(19) United States
(12) Patent Application Publication
(10) Pub. No.: US 2011/0208740 A1
(43) Pub. Date: Aug. 25, 2011

(54) ASSOCIATING DATA WITH R-SMART CRITERIA

(75) Inventor: Thomas W. Lynch, Galveston, TX (US)

(73) Assignee: LIANG HOLDINGS, LLC, Wilmington, DE (US)

(21) Appl. No.: 13/100,823

(22) Filed: May 4, 2011

Related U.S. Application Data
(63) Continuation of application No. 11/936,682, filed on Nov. 7, 2007.
Application No. 11/936,682 is a continuation of application No. 11/936,693, filed on Nov. 7, 2007, now abandoned.
Application No. 11/936,693 is a continuation of application No. 11/936,704, filed on Nov. 7, 2007.

(51) Int. Cl. G06F 17/30; G06F 15/16; G06F 3/01

(52) U.S. Cl. 707/737; 709/206; 715/753; 707/E17.089

(57) ABSTRACT

Organizing information and/or contacts using emotient properties are provided. A method can include associating respective emotient attributes with contacts utilizing respective index values, and grouping at least two contacts of the contacts into a group based on at least one index value of the index values. The method can further include defining an event by at least one of a time interval or a scenario related to the time interval; receiving, during the event, a message from a contact of the contacts including information associated with the contact; and determining, based on the information, a membership of the contact in the group. Another method can include receiving an emotient property of a contact associated with information, and associating the emotient property with the information utilizing an index value. Further, the method can include providing at least a portion of the information based on the index value.

### RELATED APPLICATIONS

This application claims priority to the following: U.S. patent application Ser. No. 11/936,682, filed on Nov. 7, 2007, entitled “R-SMART PERSON-CENTRIC NETWORKING”; U.S. patent application Ser. No. 11/936,693, filed on Nov. 7, 2007, entitled “MANAGING COMMUNICATIONS ON AN R-SMART NETWORK”; and U.S. patent application Ser. No. 11/936,704, filed on Nov. 7, 2007, entitled “MANAGING DATA USING R-SMART CRITERIA”. The entireties of the aforementioned applications are incorporated by reference herein.

### BACKGROUND

Communication is an increasingly important component of most people's lives and the average person can make contact with hundreds of other people. There is an increasing trend in the number of contacts, and this has created new challenges for managing contacts.

Some social scientists maintain that most communication is emotional and that analytical content is secondary, if present at all. Whether justified or not, caring and emotions are frequently termed “right brain” activities, and hence being good at these activities is sometimes referred to as “r-smartness” which is short for “right brain smartness”.

People often use r-smartness in determining how they communicate with other people. In some cultures this can be very pronounced, and can even affect the vocabulary and grammar of a conversation. For example, in pre-modern Europe, third person and indirect terms were used when conversing with royalty. As another example, in Japan different forms are used depending on whether one is speaking to children, family, co-workers, elders and bosses. Take for instance the Japanese word for thank you. It can take the form of “domo”, “domo arigato”, and “domo arigato gozaimasu” depending on the perceived acting role and status difference in the conversation. Thus, in this context, acting roles can include such things as parent-child, student-teacher, employee-boss, among others. Furthermore, status differences can be based on age, attainment in a skill, spiritual attainment, money, among others. Indeed, this also exists in a less formal form in American English with “thanks”, “thank you”, and “thank you very much” and other variations said in different tones and intonations. However, r-smartness comes into play in a variety of situations, not just when saying thank you.

As telecommunication means have diversified from simple land-line phones to include, among others, personal digital assistants (PDAs), cell phones, email devices such as desktop computers and laptops, and the like, the use of simple phone books and operator assistance can no longer be optimum means for keeping track of contacts. As a result, personally owned contacts lists are playing a larger role in people's lives. Enhancing such personally owned contacts lists can result in smoother communications and enhanced productivity.

Moreover, other forces, such as high-powered marketing and identity theft, have caused people to become more reticent about giving out or publishing contact information. This trend has placed pressure on individuals to organize their own contact lists rather than to rely upon a central source such as a phone book or directory service, so that, once again, the personal contacts list, and r-smartness is becoming more important.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example of an implementation of an r-smart person-centric hub and spoke network;

FIG. 2 illustrates an example of an implementation of an r-smart person-centric network;

FIG. 3 illustrates a textual representation of the example implementation of FIG. 2;

FIG. 4 illustrates an example of an implementation of a hierarchical r-smart person-centric network;

FIG. 5 illustrates an example contact form that can be utilized with the example implementations of FIGS. 2-4;

FIG. 6 illustrates an example method;

FIGS. 7 and 8 illustrate example scenario lists;

FIG. 9 illustrates an example implication rule;

FIG. 10 illustrates an example method;

FIGS. 11 and 12 illustrate examples of contextual filtering of data;

FIGS. 13 through 17 illustrate example message headers;

FIG. 18 illustrates another example of contextual filtering of data;

FIGS. 19 and 20 illustrate example methods; and

FIG. 21 illustrates an example system.

### DETAILED DESCRIPTION

### R-Smart Person-Centric Networking

In the following detailed description, numerous specific details are set forth to provide a thorough understanding of claimed subject matter. However, it will be understood by those skilled in the art that claimed subject matter can be practiced without these specific details. In other instances, well-known methods, procedures, components and/or circuits have not been described in detail.

Some portions of the following detailed description are presented in terms of algorithms and/or symbolic representations of operations on data bits and/or binary digital signals stored within a computing system, such as within a computer and/or computing system memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing can involve physical manipulations of physical quantities. Typically, although not necessarily, these quantities can take the form of electrical, magnetic and/or electromagnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's processors, memories, registers, and/or other information storage, transmission, and/or display devices.

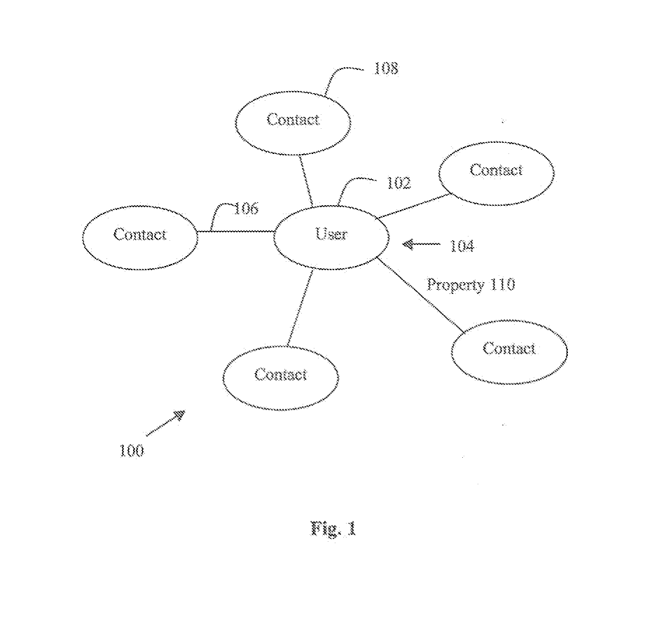

FIG. 1 illustrates one implementation of a person-centric network 100 in accordance with claimed subject matter. A person-centric network in accordance with claimed subject matter can comprise and/or be represented as a “hub and spoke” network with a person at the hub of the network, and people and/or entities they know on the other end of the spokes. Thus, in the example implementation of network 100, a contact database user 102 is located in the center of network 100 as a hub 104 of network 100. From hub 104 a plurality of spokes 106 connect user 102 to a plurality of contacts 108. User 102 and/or contacts 108 can comprise persons and/or entities such as business entities, for example.

In accordance with some implementations of claimed subject matter any one of spokes 106 can be associated with one or more “emotience” or “emotient” attributes, emotient characteristics and/or emotient properties 110. In some implementations, an emotient property 110 associated with a spoke 106 can comprise a property value list including, in a non-limiting manner, such characteristics as familiarity, affection, respect and/or respect level, esteem and/or esteem level, status and/or status difference, acting role, among others. In other words, such properties can reflect how a user feels about a personal contact.

Further, an emotient property can have a value; the value in turn can be a property, or even another property value list. Thus, in some implementations of claimed subject matter, an emotient property comprising a familiarity property can have an integer value that describes how well user 102 knows one of contacts 108. For example, an integer value of “0” can represent user 102 having no familiarity with a particular contact 108, while an integer value of “10” can represent user 102 having intimate knowledge of a particular contact 108. In other implementations of claimed subject matter, rather than numerical values, values associated with an emotient property such as a familiarity property can comprise another property value list such as “stranger”, “acquaintance”, “close”, and “intimate” among other possibilities.

In some implementations of claimed subject matter an emotient property 110 can be associated with derived properties where derived properties can comprise properties derived from a base or fundamental property value list comprising a property 110. Accordingly, properties that appear in a base property value list can be considered to be fundamental properties while derived properties can be created from fundamental properties by a rule, set of rules, algorithm, program or the like. In various implementations, derived properties can be created dynamically as needed, can be stored back into a base property value list, and/or can be placed in one or more auxiliary property value lists.

As one example among many, a derived property of affection could be determined from fundamental emotient properties such as familiarity, acting role, etc. In this context, an example rule for creating a derived property of affection can be to assume affection for the acting role of ‘wife’. In general, rules and algorithms for generating derived properties can combine a number of factors, some of which can be externally influenced. An example of an externally influencing factor can comprise a “number_of_contacts” factor. Such a factor can comprise an emotient property taking an integer value that an algorithm increments each time contact is made with a particular person. Thus, for example, an r-smart contacts database in accordance with some implementations of claimed subject matter can then derive a value for an affection, or similarly-named, property based on a respect level and a number of contacts provided by the integer value.

As another implementation of derived properties in accordance with claimed subject matter, one or more emotient properties can be determined based on common properties, and/or common property values among a plurality of contacts. In this context the term “ring” can be used to describe the grouping of contacts and the phrase “ring properties” can be used to describe emotient properties associated with a group of contacts. Similar meanings of the term “ring” can be found, for example, in the area of abstract algebra, and in colloquial terms such as “crime ring”. Claimed subject matter is not limited in this regard however, and, thus, a grouping of contacts in accordance with claimed subject matter can be described as a “ring”, a “group”, a “domain”, to name just a few examples. Thus, within this disclosure, use of the term “ring” should not be understood as describing a literal geometric shape, even though such shapes can be employed in network diagrams, etc., that can be used to illustrate example implementations of claimed subject matter.

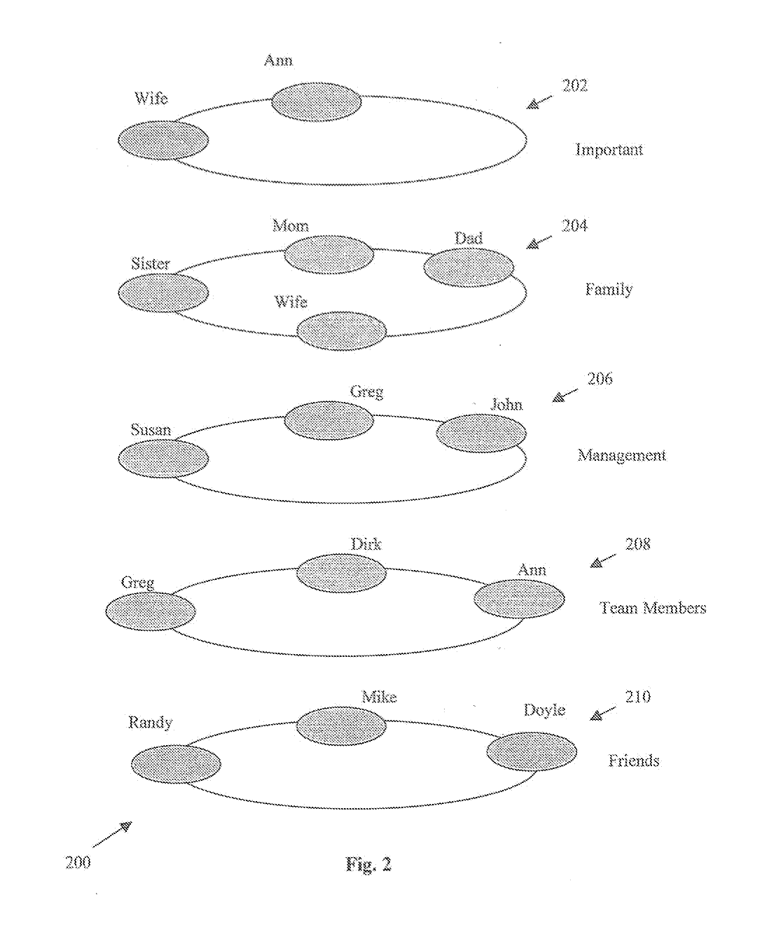

FIG. 2 illustrates an example implementation of a person-centric network 200 in accordance with claimed subject matter. In FIG. 2, an example “acting role” derived property has generated a plurality of rings 202, 204, 206, 208 and 210, carrying the values of “important”, “family”, “management”, “team member”, and “friend”, respectively. In some implementations, such as network 200, the common property and/or property value associated with the one or more subsets of contacts can be used to label or name the rings derived from those one or more subsets of contacts.

In comparison to FIG. 1, where emotient properties 110 were illustrated associated with spokes 106 connecting user 104 to various contacts 108, network 200 is illustrated without spokes because contacts within each ring 202-210 share a common emotient property and/or property value with respect to a user of network 200. For example, all contacts of ring 202 share a common property value, in this example, the value of “important”, with respect to a user of network 200. Thus, spokes are not shown explicitly in network 200 because they can be implied from the definition of the term ring as provided herein. Similarly, no hubs (associated with a user of network 200) have been illustrated in FIG. 2 because they can be implied as well.

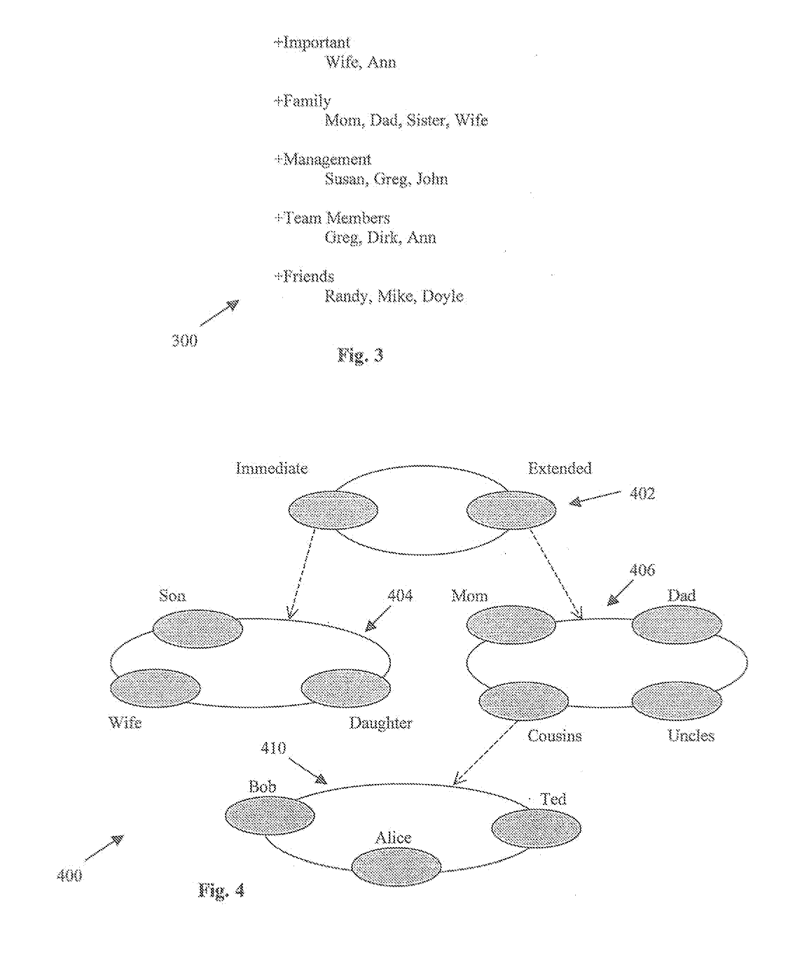

FIG. 3 illustrates an example, in accordance with claimed subject matter, of a textual rendering 300 of network 200. While textual rendering 300 may not illustrate contact groupings having particular geometric shapes such as rings, it conveys the same information as conveyed in FIG. 2.

### User Interface Network Editor and Viewer

In some implementations of claimed subject matter, r-smart information associated with a person-centric network can be created, edited, and/or viewed by separate programs, or a combined program in order to create editor/viewer functions. Such a program or collection of programs can be called an “emotience manager” although claimed subject matter is not limited in this regard. Such a program or programs can render r-smart information in graphical form as shown in FIGS. 1 and 2, in textual form as shown in FIG. 3, or in a number of other forms, where that graphical form can comprise at least a portion of a graphical user interface (GUI) capable of being displayed on a display device. The particular form used can be a user preference, or even a function, for example, of a display device employed by a user. For example, for a user employing a cell phone to view a person-centric network, a textual form as shown in FIG. 3 can comprise an optimal graphical format. Further, a user interface network editor and/or viewer can, in accordance with claimed subject matter, be accessed (e.g., for reading and/or editing) by software applications that are compatible with person-centric networks.

In some implementations, a user can select (e.g., click on) a display form to cause one or more actions to occur. For example, a user clicking on a category label can cause an underlying list to collapse or expand. Further, a user clicking on elements of a list can cause details for a contact to be rendered. Rendering of such details can be provided by an editor function where contact information can be modified and or supplemented, and preferences such as a primary label, for example, can be set.

It should now be apparent to those skilled in the art, that rendering or bringing only contextually appropriate information to the forefront can also be applied when different user interfaces are employed, including a GUI. Another possible filtering interface can comprise an interface that allows a user to explicitly select desired rings to be shown. Such an interface can present a dialog box, and allow a user to enter the names of one or more rings into the dialog box. A possible further extension of this implementation can interpret user input as a regular expression, and then present all matching categories.

In accordance with some implementations of claimed subject matter, a ring method of organizing contacts can provide a user with greater flexibility to segment contact lists into contexts that apply at any particular moment, while leaving out or de-emphasizing those that do not. Thus, for example, a user can filter communications with contacts based upon how the user feels about various contacts at particular times and/or in particular contexts. As an example of this filtering, a user who is at the office can feel that communications with co-workers and/or supervisors are more important and thus can turn off or de-emphasize family and/or friend's rings so that more immediately useful work-related contacts are emphasized in the foreground of an interface's graphical rendering. Whereas, in contrast, a user in the context of a family event, such as wedding or family reunion, can feel that family contacts are more important and therefore make a family ring the immediate and most easily accessible ring.

### Hierarchical Rings

In accordance with some implementations, r-smart person-centric networks can be hierarchical in format. For example, a “family” ring or group can be further broken down into sub-rings or sub-groups such as “immediate family” (such as wife, son, daughter, etc.), and “extended family” (such as mom, dad, uncle, cousin, etc.). Such hierarchical groupings can extend for multiple levels of sub-rings; for example, “cousins” in an extended family ring might open up or be selectable to reveal a sub-ring providing a list of all cousins. For example, FIG. 4 illustrates an example ring network 400 where a “family” ring 402 having “immediate family” and “extended” family contacts supports sub-rings 404 and 406 comprising, respectively, contacts within the immediate family and contacts within the extended family. The contact 408 labeled “cousins” in the extended family sub-ring 406 can then spawn a further sub-ring 410 comprising all cousin contacts. As noted above, contacts within rings or sub-rings of network 400, can, depending on the user interface employed to display network 400, permit a user to select a contact, such as, for example, the “cousins” contact 408 of extended family sub-ring 406, to display any associated sub-rings such as sub-ring 110.

### Nature of Contact Information

In general, contact information can be quite extensive and/or arbitrary. In some implementations of claimed subject matter, the nature of contact information can reflect an application and/or a ring. For example, friends and family contacts can have names and addresses with phone numbers and email addresses. In contrast, employment-related contacts can include office addresses and phone extensions. In some implementations of claimed subject matter, a context of a contact can be entered along with other contact information. For example, in accordance with some implementations of claimed subject matter a contact manager enhanced to support r-smart person-centric networks can provide an enhanced format for a user to enter contact information.

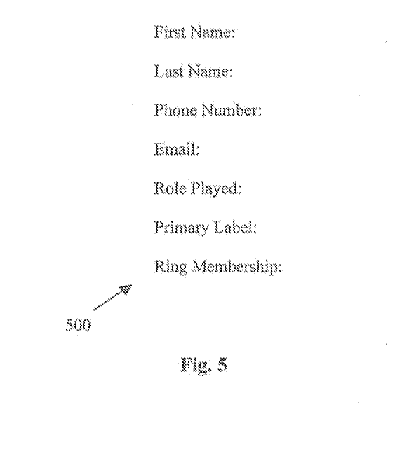

FIG. 5 shows one example embodiment of an enhanced contact form 500 in accordance with some implementations of claimed subject matter. Of course, form 500 is just one of many possible contact forms suitable for person-centric networks. As shown in FIG. 5, the example of form 500 includes the following fields for entering contact information: first name, last name, phone number, email, role played, primary label, and ring membership. Thus, using enhanced form 500 a user can directly enter a role played by a contact, a primary label associated with a contact and a list of ring memberships for a contact. For example, for a business contact that is also a friend, a user of form 500 can enter a primary label of “work” for that contact while also listing membership for that contact in both a “work” ring and a “friends” ring.

In other implementations in accordance with claimed subject matter, an application can support a ring manager separate from a contacts list manager. In such implementations, a user can add contacts to one or more rings rather than adding rings to the contacts. Many other variations will be apparent to those skilled in the art.

In yet other implementations in accordance with claimed subject matter, a primary label can be implied or derived from other information potentially in combination with user preferences. Further, some or all of the information on a form can be optional. In addition, there can be a default ring for those who are not placed on any ring.

### Internal Representation

In some implementations in accordance with claimed subject matter, r-smart person-centric networks such as rings can be internally defined using list structures. Accordingly, the head of a list can comprise a ring name, and subsequent members of the list can comprise references to members of a ring. Sub-lists can represent hierarchical information within such list structures.

For example, a person-centric list structure in accordance with claimed subject matter might take the following form: (ring-top (Important Wife Ann) (Family Mom Dad Sister Wife (cousins Rick Rob Cindy Kevin)) (Management Susan Greg John) (Team Members Greg Dirk Ann) (Friends Randy Mike Doyle)).

Such person-centric list structures in accordance with claimed subject matter can be in various formats such as American Standard Code for Information Interchange (ASCII) format, binary format, etc, the particularly format not being limiting. In some implementations, labels such as the primary label “important” can comprise references such as database keys or address pointers, among many other possibilities. Further, instead of a list structure, some implementations in accordance with claimed subject matter can employ data structures or arrays to define r-smart person-centric networks. Many other forms of internal representations will be apparent to those skilled in the arts of computer programming.

### Special Rings

Some implementations in accordance with claimed subject matter can define special rings. Such special rings can include, for example, “everybody” and “nobody” rings where an everybody ring can comprise a flat contact list that includes all contacts, and a nobody ring can contain all contacts that do not belong to any other ring. Various implementations can give such special rings names other than “everybody” and “nobody”.

Example Method For Associating Data with R-Smart Criteria

FIG. 6 is a flow diagram of an example method 600 in accordance with some implementations of claimed subject matter. Method 600 can implement and/or perform some or all of the various functions and/or schemes discussed above in connection with FIGS. 1-5 and details regarding the various acts of method 600 have been provided above in reference to those figures and will not be repeated below in the discussion of FIG. 6. Any ordering of the acts shown in FIG. 6 does not limit claimed subject matter and does not imply that the acts must be undertaken in the order shown and/or that any particular act in FIG. 6 is necessarily dependent upon another act.

In act 602, a plurality of personal contacts can be provided, while in act 604 those personal contacts can be organized by associating them with at least one emotient property. Further, in act 606, at least some of those contacts received in act 602 can be organized into at least one group (e.g., a ring) comprising contacts having a common property. The at least one group formed in act 606 can, in act 608, be further organized into a plurality of sub-groups. In addition, in act 610, an internal representation of the groups and/or sub-groups can be formed comprising at least one of a list structure, a data structure and/or an array. Also, in act 612, at least one derived property can be determined.

### Managing Communications on an R-Smart Network

In the context of this disclosure, and the claims that follow, the term “ring” can be used to describe the grouping of personal contacts and the phrase “ring properties” can be used to describe properties associated with a group of contacts. Similar meanings of the term “ring” can be found, for example, in the area of abstract algebra, and in colloquial terms such as “crime ring”. Claimed subject matter is not limited in this regard however, and, thus, a grouping of contacts in accordance with claimed subject matter can be described as a “ring”, a “group”, a “domain”, to name just a few examples. Thus, within this disclosure, use of the term “ring” should not be understood as describing a literal geometric shape, even though such shapes can be employed in network diagrams, etc., that can be used to illustrate example implementations of claimed subject matter.

For many individuals the day can be partitioned into time intervals and/or event categories having related purposes. For example, early hours can be for preparing for the day, morning and afternoon hours can be spent at the office, the noon hour can be for lunch, the early evening can comprise personal time, the dinner hour and late evening hours can be dedicated to family, and the weekends can be devoted to recreation, etc. For purposes of this disclosure, time intervals and/or event categories and/or types of situations can be referred to simply as “scenarios” or “events”. Further, in accordance with claimed subject matter, scenarios can be associated with scenario “properties”. For instance, in the above example, scenario properties can include, “preparation” associated with a morning scenario, “lunch” associated with a noon hour scenario, etc.

Further, while scenarios can be associated with a specific time interval or period, claimed subject matter is not limited in this regard. Thus, scenarios in accordance with claimed subject matter can be defined with respect to any contextual elements that can be associated with a set of behavioral expectations that, in turn, can be associated with specific temporal circumstances. In addition, in the context of this disclosure and/or claimed subject matter, contextual elements of a scenario can set behavioral expectations associated with that scenario and can include, but are not limited to, time of day and/or year, social setting (e.g., work, family, friends, etc.), etc. Hence, for example, a “business meeting” event could occur at any time, although for many individuals there might be an expectation that such a scenario would occur between 8 AM and 5 PM on weekdays. For another example, an “in transit” or “traveling” property can be associated with a “vacation” scenario or event where the property of being “in transit” can be somewhat randomly temporally associated with the “vacation” scenario that, in turn, can represent a “one off” or asynchronous event.

Yet, further, in accordance with claimed subject matter, scenario or event names themselves can comprise properties. For example, a morning scenario can be associated with a name property comprising “morning”, a noon hour scenario can be associated with a name property comprising “noon hour”, etc. In some embodiments of claimed subject matter, scenarios can be described by a list format.

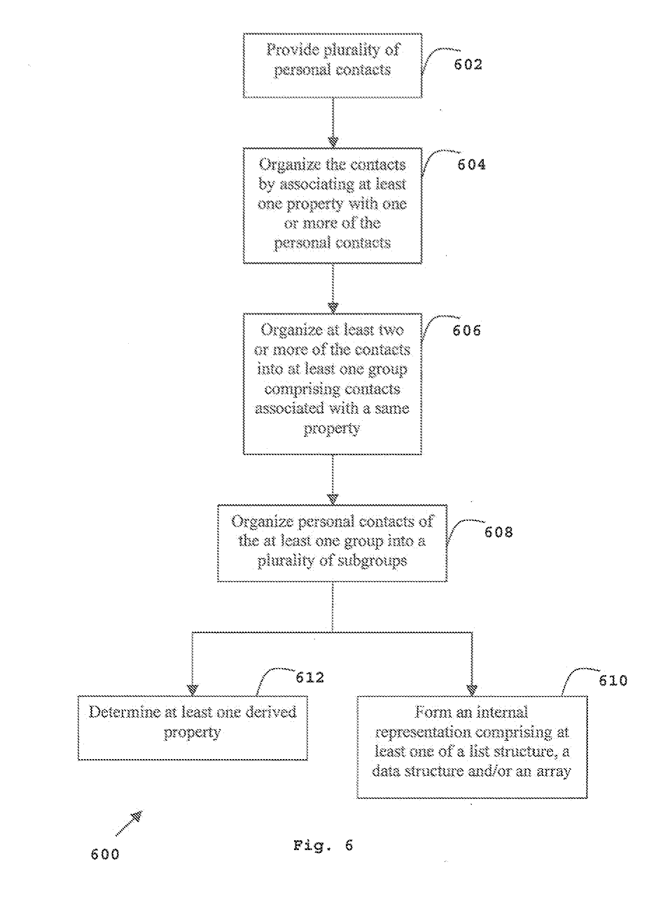

FIG. 7 illustrates an example scenario properties list 700 in accordance with some implementations of claimed subject matter. As shown in the implementation of FIG. 7 a scenario name can be the first property listed. Those skilled in the arts of programming and databases can recognize many other possible schemes for listing scenario information. Hence, list 700 should be considered pedagogical and not limiting with respect to the conveyance of scenario properties. In accordance with claimed subject matter, other properties associated with a named scenario can follow a scenario name. In the example of list 700 each scenario has been associated with one property. Claimed subject matter is not limited in this regard, however, and, hence, any number of properties can occur within a list and/or can be associated with one or more scenarios.

Those skilled in the art can recognize that textual representations of lists having embedded spaces, such as in scenario names of FIG. 7, can be problematic. One commonly used solution to the embedded space problem comprises using a back slash as a special escape character. In such schemes a back slash followed by a space can be considered to comprise a space embedded in the identifier, rather than as a delimiter between identifiers. While list 700 as shown employs a back slash as a special escape character, many other techniques, well known to those familiar with the art, can be employed for dealing with embedded spaces, and the use of this technique in list 700 should not be construed to limit claimed subject matter in any way.

Furthermore, in accordance with some implementations of claimed subject matter, properties themselves can be associated with sub-properties. In such implementations, when represented using a list method, a property and its associated sub-properties can appear as a sub-list. FIG. 8 illustrates, in accordance with some implementations of claimed subject matter, an example scenario list 800 that employs both multiple properties and associated sub-properties.

In the example implementation of FIG. 8, a scenario named “morning” is associated with three properties, “preparation”, “commute”, and “interval”. In turn, the morning interval property is associated with two sub-properties, namely “8 am” and “9 am”. Scenarios are not, however, limited to being associated with names. Thus, in some implementations of claimed subject matter, properties themselves can convey useful information. Moreover, in implementations of claimed subject matter employing list representations, the lack of a name can be represented by, for example, the 'nil symbol.

Implementations employing list representations, such as shown in the example implementations of FIGS. 7 and 8, are not intended to be limiting in any way, and, thus, many other schemes exist for the expression of scenario properties and analogous items in accordance with claimed subject matter. For example, in other implementations, a graphical calendar can be employed. In such implementations, properties can be implied with respect to appointments on a calendar. Some of these appointments can be recurring. Further, in some implementations in accordance with claimed subject matter, electronic schedule calendars can be modified to allow a user to explicitly express scenario names, their times of occurrence, and/or associated properties. For example, consider the noon hour scenario of list 800. A user with a calendar application that has been modified to support scenarios in accordance with claimed subject matter can create a recurring scenario between 12 and 1 every weekday. Such a scenario can differ from an appointment because it describes a customary scenario that occurs during a particular time interval and does not necessarily imply a meeting or any other specific event. In accordance with some implementations of claimed subject matter a scheduled scenario of a modified calendar program can be edited to add additional scenario properties.

To further illustrate, another example general scenario or event can be a “business meeting”. Similar to other scenarios described herein, individuals can have certain expectations or behavioral norms associated with events such as business meetings. For example, a user can expect that a phone does not ring, but rather vibrates during a business meeting. Further, a user can expect that if a call is from the user's “boss” then the phone should ring during a business meeting scenario whereas, if a call is from an “important” contact and/or someone the user holds in high esteem, then the phone should vibrate only, or, if the call is from anyone else then the phone should remain silent. In accordance with some implementations of claimed subject matter, algorithms executing on a phone or other communications device can be supplied, modified, etc. such that, for communications originating from certain contacts, the device can divert a call over to voice mail rather than vibrate when a distant relative calls during a business meeting for example, or undertake various other actions in different scenarios or events depending upon who is attempting to contact the user and/or how the user has categorized the contact.

In accordance with some implementations of claimed subject matter, user contacts can also be associated with properties. Various implementations exist for binding properties to contacts and capturing property information in accordance with claimed subject matter. One such implementation comprises a list representation, such as introduced above in FIGS. 7 and 8 for scenario properties. In some implementations employing list representations of contact properties, a head of a list can comprise a reference to a contact. There are many ways to reference a contact, such as by address pointer, record id, index, and primary label, contextual implication, among others. Subsequent to a contact reference, a list representation of contact properties can include a list of properties associated with the contact. As for list representations of scenario properties, properties in a list representation of contact properties can be associated, in a nested manner, with sub-properties.

In accordance with some implementations of claimed subject matter, a property that can be associated with one or more contacts can be the role those contacts play in the users life. For example, role properties can include “father”, “mother”, “wife”, “boss”, “accountant”, “school principal”, etc.

Similar to the manner in which scenarios and contacts can be associated with properties, relationship rings can also be associated with properties. In this disclosure and the claims that follow a relationship ring, or simply a “ring”, can comprise a group of personal contacts where that group shares a common property such as a degree of familiarity and/or affection, a respect, status, and/or esteem level, and/or an acting role. In other words, such properties can reflect how a user feels about a personal contact.

In some implementations of claimed subject matter employing list representations, a list head can comprise a reference to a ring, while the list itself provides properties associated with that particular ring. As in the case of scenarios and contacts, many implementations for properties associated with a relationship ring can be apparent to those skilled in the art. For example, in some implementations, a property of a ring can comprise a list of references to contacts belonging to the ring. For another example, a relationship ring can be associated with a “notification level” property comprising an integer sub-property. If, for example, a notification level property is set low for a particular ring, then a notification (e.g., ringing sound) regarding communications (e.g., calls, emails, etc.) received from that ring can be provided to a user at a lower volume, depending on the user's particular scenario.

In accordance with claimed subject matter, properties associated with scenarios, contacts and/or relationship rings are not limited to a particular format. Thus, in some implementations, properties can, for example, comprise data in an American Standard Code for Information Interchange (ASCII) format, while in other implementations, properties can, for example, comprise data in a binary format. Moreover, in accordance with claimed subject matter, property lists can have many analogous structures, including data structures, Extensible Markup Language (XML), indexed arrays, among many others. Moreover, claimed subject matter is not limited to the term “property”, and thus, in some implementations, different nomenclature can be used so that properties can be called attributes, indexes, references, additional information, or be referred to by a myriad of different terms.

In accordance with claimed subject matter some properties can be assigned to different agents. For example, ring membership can be associated with a relationship ring as a property of that ring. In some implementations, ring membership can be explicitly listed as a property of a ring, while in other implementations ring membership can be implied. For example, ring membership property can be implied when ring relationships are listed for contacts. Similarly, many other properties will also take implied or explicit forms, or can be attached to various agents. Further, in some implementations in accordance with claimed subject matter, properties belonging to a ring can be inherited by sub-rings and/or by contacts belonging to a ring or sub-rings.

In some implementations of claimed subject matter, communication related status can include properties related to a state or state(s) of a terminal unit or communication device. For example, in some implementations, a communication related status for a cell phone can comprise “busy”. In this context, the property busy can exist when someone is talking on the phone. In other implementations, a more sophisticated form of such a property can convey a number of people engaged in communication on a terminal unit, for example, “engaged_number”. Thus, in some implementations, a property can be properties. For instance, using the example of an engaged_number property, a particular value for this property might be “engaged 3” signifying that a user can be on a conference call with two other individuals at a particular moment. In general, communication related status properties can be implied by terminal device hardware, a context that a control program executing on a terminal device is in, or listed explicitly somewhere in a communications system or even in a computer registry, among a myriad of other possibilities.

In some implementations of claimed subject matter, a communication action can comprise an action that a terminal device undertakes when handling communication. Again, such a communication action can comprise a property associated with a terminal device and/or a communications system. For example, if a laptop computer emits a sound (e.g., chimes) when new mail arrives, the act of emitting a sound can comprise a communication action. Thus, for one example, a terminal device (e.g., laptop), can employ a communication action “do_sound(N)” where the function “do_sound” includes an argument “N” determining the volume at which the terminal device emits a sound. As another example, when a call reaches a cell phone, the phone can ring with a special ring tone, or vibrate. Such functions can, in some implementations of claimed subject matter, comprise communications action properties such as, for example, “do_ring(ring_tone)”, or “vibrates”, etc. For example, a communications action comprising a do_ring function can accept an integer argument that specifies which ring tone to use.

Other communication actions can control initiating communication, handling interrupts, and a host of other things. These are just a few examples and because actual interfaces used on devices vary widely across manufacturers, across models, and even across software releases and applications employed, among other variables, claimed subject matter is not limited to the few examples presented herein. Moreover, a communication action may not appear explicitly in source code, for example, but can be implied, mixed in with other actions, placed in hardware, be a mixture of these, or have other variations, claimed subject matter not being limited in this regard either.

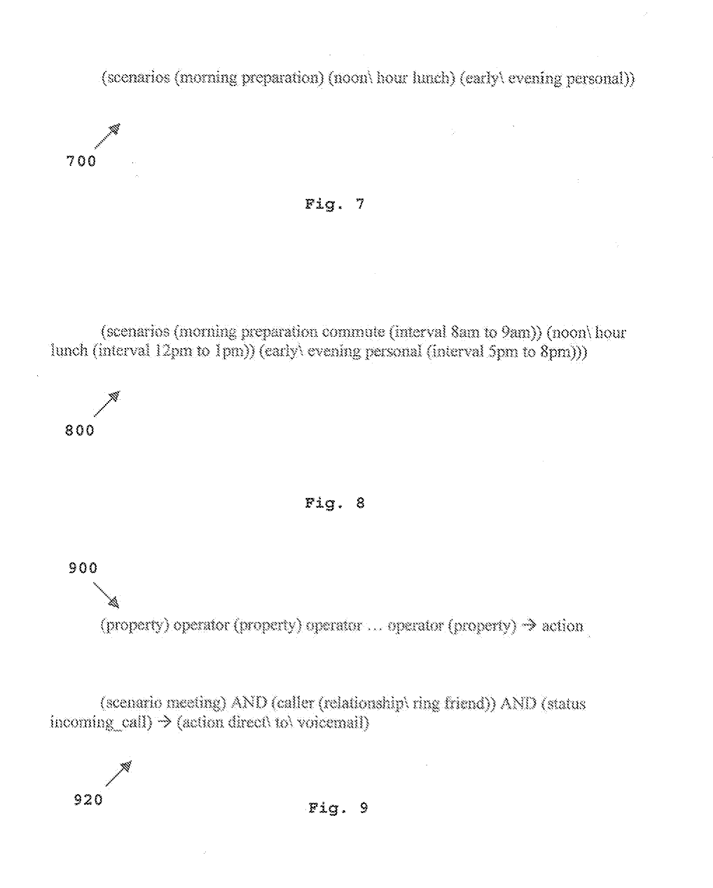

In some implementations of claimed subject matter, implication rules can employ operators to act on properties in order to invoke communication related actions. Operators can comprise any function that operates on properties that a particular device can implement either directly or indirectly. For example, a common operator can comprise a conjunction. FIG. 9 illustrates a general implication rule 900 and an example implication rule 920 employing conjunction operators.

In FIG. 9, example implication rule 920 directs incoming calls received from those contacts belonging to a friend relationship ring to voicemail when those calls are received during a meeting scenario. In this example, implication rule 920 conjoins three properties 922, 924, and 926 (not shown): property 922 associated with a current scenario, property 924 derived from comparing a caller id with relationship ring information, and property 926 identifying that the communication event comprises an incoming call. Thus, in example rule 920: property 922 specifies a meeting where this property can have been derived from a calendar combined with a current time, and property 924 can be derived from comparing a caller id with relationship ring information where the relationship ring information identifies that the caller is calling in the role of a friend. In some implementations of claimed subject matter, a caller can choose to call in any one of a number of different roles.

The third property of rule 920, property 926, identifies that the communication event comprises an incoming call. It should be understood that in some implementations, for example when a terminal device comprises a multimedia device, a communications event could comprise an incoming call, a text message, or an email, among other possibilities. The arrow in rules 900 and 920 signifies the implication operator whereas the items on the left side of the implication operator (e.g., properties 922, 924, 926 in rule 920) are used to trigger the implication. Thus, in the context of rule 920, the right side of an implication rule indicates what to do when the left side is satisfied. Hence, rule 920 provides that a conjunction of being in a meeting and having a friend call triggers action 928 (not shown) thereby sending the call directly to voice mail.

In some implementations of claimed subject matter, implication rules, such as rule 920, can be created in advance, and made active by a user. In various implementations, such rules can be active all of the time, or turned on and off, depending, for example, on a given scenario and/or on user preferences. Further, some implementations can support a variety of operators. For example, some implementations can affect some or all of, among others: +−*></== AND OR XOR ON OFF DURING PROCEEDING AFTER, etc. Claimed subject matter is not limited to specific operators and the preceding list is not intended to be an exhaustive listing of all possible operators.

While examples of communications actions have been provided above, there are many possible communication actions in accordance with implementations of claimed subject matter. For further example, another type of communication action in accordance with some implementations of claimed subject matter can comprise an automatic response. Further, when employing implication rules in accordance with some implementations of claimed subject matter responses can be provided based on rings, roles, and/or scenarios. For example, in some implementations, unknown callers can be told to send email to an administrative address.

Further, in accordance with some implementations of claimed subject matter, scenarios or events can be employed to classify appointments on a calendar. For example, meetings with contacts from particular relationship rings can imply that a scheduled meeting comprises a business meeting. Such expectations can be captured in, for example, calendar appointment implication rules. In this context, an implication rule can generate a property that can in turn be used in other rules. Thus, in accordance with some implementations of claimed subject matter, once calendar implication rules have been generated, appointments placed on a calendar can automatically invoke certain rules and/or create scenario properties.

In some communications systems, in accordance with some implementations of claimed subject matter, one or more implication rules can be provided by default by manufacturers and/or designers of such systems. In some implementations, some and/or all of these rules can be modifiable by the user. In various implementations, implication rules can be modified by an application programmer, a user, a system administrator, or any combination of these or other means.

In accordance with some implementations of claimed subject matter, additional implication rules can be chosen by a user from a menu system. In other implementations, a user can invoke a rule management application permitting the user to add new rules, delete old rules, and perform various rule maintenance functions. Such a rule management application can include a rule editor permitting a user to create implication rules by concatenating selected properties, operations, and implied actions from selections on various menus. In accordance with some implementations of claimed subject matter, a user can be allowed to directly enter and/or formulate rules using a grammar or format, such as shown in the examples in this application or via a different grammar or format. Further, in accordance with some implementations of claimed subject matter, implication rules can take the form of programs or algorithms accepting as input various properties to be affected, and calling actions as other routines in the system. Further, in some implementations, implication rules can be programmed in field programmable devices, or embedded directly in hardware.

Example Method Related to Associating Data with R-Smart Criteria

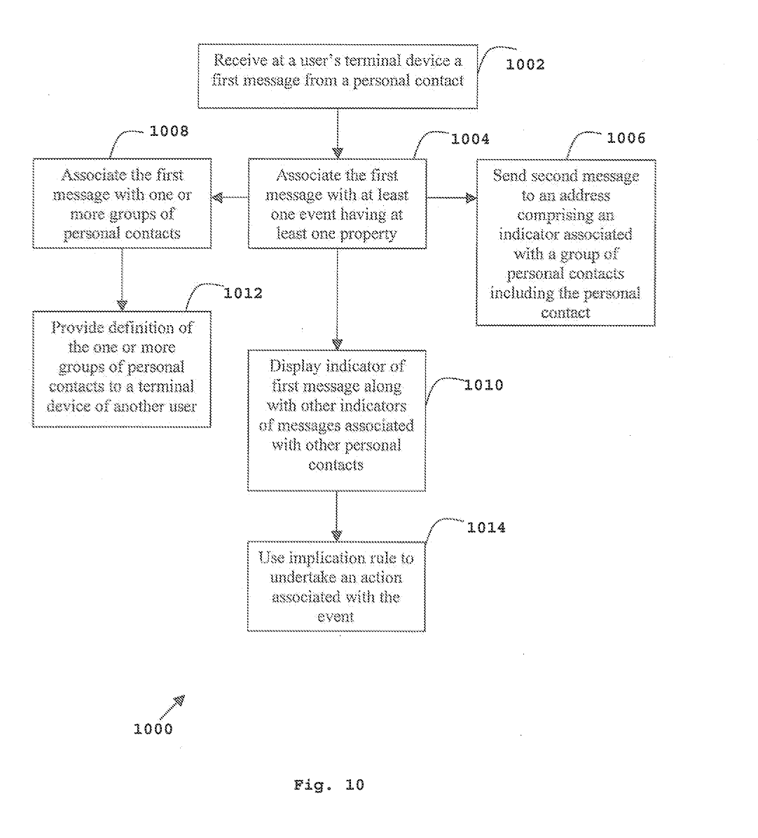

FIG. 10 is a flow diagram of an example method 1000 in accordance with some implementations of claimed subject matter. Method 1000 can implement and/or perform some or all of the various functions and/or schemes discussed in connection with FIGS. 7-9 and 21, and details regarding the various acts of method 1300 have been provided above in reference to those figures and will not be repeated below in the discussion of FIG. 10. Any ordering of the acts shown in FIG. 10 does not limit claimed subject matter and does not imply that the acts must be undertaken in the order shown and/or that any particular act in FIG. 10 is necessarily dependent upon another act. In the description of FIG. 10 that follows, references to the display of a message or an indicator of a message can refer to display of an associated message header along with a message or to display of an associated message header alone.

In act 1002, a first message from a personal contact can be received at a terminal device of a user, while in act 1004 that message can be associated with at least one event having at least one property. Further, in act 1006, a second message can be sent to an address comprising an indicator associated with a group of personal contacts that includes the personal contact that sent the message received in act 1002. In act 1008 the first message can be associated with one or more groups of personal contacts, while in act 1010, an indicator of the first message along with other indicators of messages associated with other personal contacts can be displayed. Further, in act 1012, a definition of the one or more groups of personal contacts can be provided to a terminal device of another user. In addition, in act 1014, an implication rule can be used to undertake an action associated with the event.

### Managing Data Using R-Smart Criteria

A data storage system can store items and can permit a user to sort, search and/or archive those items based upon particular criteria. In accordance with some implementations of claimed subject matter a user can sort, filter and/or archive items using r-smart criteria. In this disclosure, and the claims that follow, the phrase “r-smart criteria” can refer to emotient attributes associated with items where the phrase “emotient attributes” can refer to properties of familiarity, affection, respect, esteem, status, and/or acting role of entities, such as personal contacts, defined with respect to the user. In other words, emotient attributes can reflect how a user feels about an entity associated with a stored item or can feel about the item itself. For example, a user of a data storage system such as a computer hard-drive can hold photographs of the user's grandmother stored on the hard-drive in higher esteem than photographs of the user's cat that are also stored on the hard-drive. In such circumstances a user of a system in accordance with claimed subject matter can associate a different emotient attribute with pictures of the user's grandmother than with pictures of the user's cat.

In this disclosure, and the claims that follow, the term “contextual filtering” describes, at least in part, using r-smart criteria to manage stored data. In this context the terms “sorting” and “filtering” can be used interchangeably. In accordance with some implementations of claimed subject matter such “contextual filtering” need not be applied only to the sorting of items, it can also be applied to searching among items. Further, in this disclosure, and the claims that follow, the terms “manage” or “management” when employed in the context of contextual filtering describe, at least in part, searching, filtering, and/or archiving stored items.

Those skilled in the art will recognize that techniques for sorting, searching and/or archiving stored items are well established and that there are many well-known schemes for implementing data management and/or for providing a user with an interface for managing data and, hence, specific data management schemes and/or interfaces will not be described in detail herein. For example, common techniques for facilitating sorting, searching and/or archiving items include indexing meta data (e.g., file name, last access date, etc.) associated with the items and/or indexing item content. In addition, some schemes permit users to customize meta data by adding and/or altering keywords and/or tags that can also be indexed to facilitate sorting, searching and/or archiving items.

While claimed subject matter is not limited by the type of data associated with emotient attributes, in some implementations, stored message content and/or message-related data, can be sorted, searched and/or archived as a function of r-smart attributes associated with those items. For example, an email client can provide r-smart attributes associated with emails directly in the email headers and those attributes can be used to sort, search and/or archive emails. Further, in accordance with some implementations of claimed subject matter, a user can sort, search and/or archive items based on one or more “relationship ring” attributes of a message sender where those attributes can be conveyed in a header associated with the message.

As used throughout this disclosure and in the claims that follow, the phrase “relationship ring” can be used to describe a grouping of items sharing one or more emotient attributes in common. Claimed subject matter is not limited in this regard however, and, thus, a grouping of items in accordance with claimed subject matter can be described as a “ring”, a “group”, a “domain”, to name just a few examples. Thus, within this disclosure, use of the term “ring” should not be understood as describing a literal geometric shape, even though such shapes can be employed in network diagrams, etc., that can be used to illustrate example implementations of claimed subject matter.

In some implementations of claimed subject matter, items can be sorted, searched and/or archived in response to r-smart criteria using separate programs, or a combined program. Such a program or collection of programs can provide sorting, searching and/or archiving functions or utilities to a user and can be called an “emotience manager” although claimed subject matter is not limited in this regard. For example, an emotience manager can present a search function to a user permitting the user to enter and/or select r-smart criteria to be used for searching stored items. Similarly, such an emotience manager can present a sort function to a user permitting the user to enter and/or select r-smart criteria to be used for sorting or filtering stored items. Further, an emotience manager can present an archive function to a user permitting the user to enter and/or select r-smart criteria to be used for organizing the storage of items. In some implementations, an emotience data manager in accordance with claimed subject matter can enable users to attach properties such as emotient attributes to data items, enable users to set up inheritance and default rules (for communicated data for example), and to later search and retrieve items.

An emotience manager in accordance with claimed subject matter can include at least a portion of a graphical user interface (GUI) capable of being displayed on a display device. The particular form used can be a user preference, or even a function, for example, of a display device employed by a user. Further, an emotience manager can, in accordance with claimed subject matter, be accessed (e.g., for reading and/or editing) by software applications that are compatible with r-smart networks.

As mentioned above a user can utilize an emotience manager In accordance with claimed subject matter to sort or filter items. One possible filtering interface can comprise an interface that allows a user to explicitly sort or filter only items associated with particular emotient attributes. Such an interface can present a dialog box, and allow a user to enter criteria related to one or more attributes into the dialog box. The emotience manager can then filter items in response to the entered criteria. For example, in the context of relationship rings, a user can select both “family” and “business” rings and filter items associated with those rings for only those items associated with contacts that have the emotient attributes of being both friends and business associates of the user. A possible further extension of this implementation can interpret user input as a regular expression, and then present all matching categories. Clearly, those skilled in the art of data management will recognize that there are many ways to facilitate management of stored information and the above example is merely one way of doing so.

In some implementations of claimed subject matter, a user can selectively enable the display of items associated with particular emotient attributes. Thus, using again the example context of relationship rings, if a user is involved in a family event, he or she can configure an application to display only those stored items associated with members of a “family” ring of contacts. Likewise, for another example, when at the office, a user can configure an application to display only those stored items associated with members of that user's “office” ring of contacts.

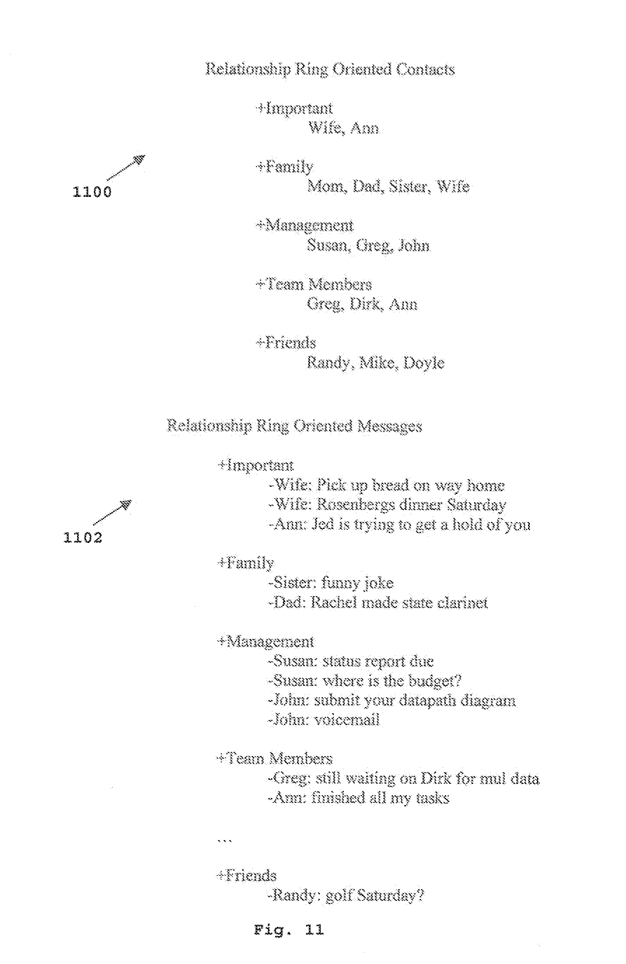

FIG. 11 illustrates, in accordance with an example implementation of claimed subject matter, contextual filtering of stored email items in the context of a contacts list organized as a relationship ring. On the left-hand side of FIG. 11 is shown a contacts list 1100 organized as a relationship ring. While on the right-hand side is shown a representation 1102 of the contents of an email inbox organized with respect to the relationship ring each sender of the mail belongs to. It should be understood, however, that FIG. 11 represents an illustrative example implementation and that no particular information shown therein should necessarily be construed as limiting claimed subject matter in any way. Also, it should be understood that claimed subject matter is directed to the management of stored data and is in no way limited to management of communications-related stored data.

In accordance with some implementations of claimed subject matter message display and/or search context can be undertaken according to emotient attributes such as relationship ring membership or ring name, etc. For instance, FIG. 12, in accordance with an example implementation of claimed subject matter, illustrates a user interface of an email application that has been configured to limit displayed items 1200 to a particular context, in this example: items received from management contacts. Further, in the example of FIG. 12, an item search can also be similarly limited in scope to items associated with management messages. Once again, FIG. 12 represents merely an illustrative example implementation and no particular information shown therein should necessarily be construed as limiting claimed subject matter.

Further, in addition to contextual filtering employing user interfaces similar to the examples shown in FIGS. 11 and 12, there are many other interfaces that can be employed to provide contextual filtering in accordance with claimed subject matter. For example, contextual filtering in response to r-smart criteria can, in accordance with claimed subject matter, comprise employing an explicit statement of a text-string to search for. Thus, for example, with contextual filtering limited to items received from “management” ring contacts, a search can be undertaken for any and all occurrences of the text-string “meeting at 1 pm” associated with those items. Moreover, for example, when search activity is constrained to a particular ring (e.g., a “management” ring), a search for “pick up bread”, for example, can fail, as such content can be associated only with items originating from members of a “family” ring. In other implementations in accordance with claimed subject matter, display context and search context may not be linked and thus, using the above example, when a display context is constrained to a management ring, a search for “pick up bread” may not fail.

Some implementations in accordance with claimed subject matter can include special rings such as, for example, “everybody” and/or “nobody” rings where an everybody ring can comprise a flat contact list that includes all contacts, and a nobody ring can contain all contacts that do not belong to any other ring. Various implementations can give such special rings names other than “everybody” and “nobody”. In such implementations, contextual filtering can give rise to special item listings. For example, limiting item display to an everybody ring can result in display of all items, while limiting item display to a nobody ring can result in display of items received from contacts who are either not in a contacts list, or who are in a contacts list, but have not been assigned to any relationship rings.

In accordance with claimed subject matter, emotient attributes can be associated with items when those items are stored so that the items, as stored, are arranged with respect to their emotient attributes. In other words, items sharing emotient attributes in common can be stored in association with each other. In other implementations of claimed subject matter, previously stored items can be subsequently associated with emotient attributes. As those skilled in the art can recognize, associating storing items with each other can mean that the items are stored in physical association with each other (e.g., in adjacent regions of memory for example) and/or it can mean that items are stored in logical association with each other, or, in other words, that within storage system the items can be associated with each other by associated each item with, for example, a common index.

Implementations of claimed subject matter are not limited to management of items associated with communications, but can include sorting, searching and/or archiving of stored items of any type and/or origin, such as, for example, digital images, application files, etc. However, within the context of communications-related items, and in accordance with some implementations of claimed subject matter, the identification associated with the sender of an item (e.g., a caller's identification) can be searched against a user's contact information to determine a relationship ring and/or a role to be associated with the item. A message sender can have volunteered, or have been prompted to supply, disambiguating information should the sender have more than one role and/or belong to more than one relationship ring. Thus, for example, an emergency contact that is also a friend could distinguish between an emergency message and a friendly message. Similarly, a wife who is also a business partner, can categorize messages into one or both roles. In such circumstances, sorting, searching and/or archiving items in response to r-smart criteria related to one role or another role can, in accordance with claimed subject matter, involve sorting, searching and/or archiving items associated with the same stored message or messages.

Further, roles associated with contacts can be hierarchical. Thus, for example, a spouse who is also a business partner can further distinguish messages associated with the business partner role based on marketing or sales, for example.

In addition, in some implementations of claimed subject matter, a recipient of an item can re-categorize the emotient attribute or attributes, such as an acting role or roles, associated with the item. Moreover, in some implementations, a user can highlight or otherwise flag one or more portions of a message and can limit categorization to those portions. Highlighted portions can then be display by themselves or as highlighted sections when items are filtered by emotient attributes.

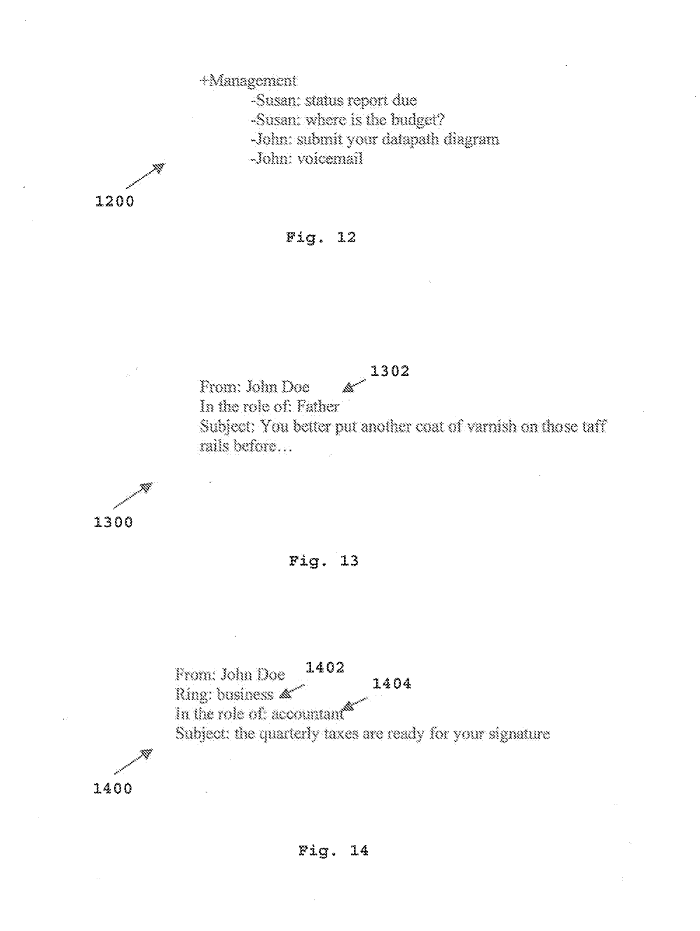

FIGS. 13 and 14 illustrate an example implementation wherein a contact “John Doe” belongs to two rings: a “family business” ring, and a “family member” ring. In the example implementation of FIGS. 13/14 an email application can support, in accordance with claimed subject matter, use of email keywords for the purpose of disambiguating messages. Thus, in FIG. 13, contact John Doe has added a header key 1302 to signify the role from which he is speaking in the stored item 1300. While in FIG. 14, the contact has, associated with a item 1400, provided both a key 1402 for the ring he belongs to on the receiver's email application, and has provided a key 1404 for his role. Hence, in accordance with claimed subject matter, sorting, searching and/or archiving items associated with item 1300 can be undertaken in response to criteria including either or both of keys 1402 and 1404.

While r-smart criteria can be utilized, as described in various examples above, to filter or search items, in addition, r-smart criteria can also be used to archive items in accordance with claimed subject matter. Thus, in accordance with claimed subject matter, a user can employ r-smart criteria to organize or otherwise specify certain stored items as belonging to a specific collection of items. For example, a user can wish to organize all stored items relating to a particular r-smart criteria such as all items received from contacts that are both held in particular esteem by the user and that share a common acting role (e.g., messages from co-workers that are also friends of the user). The user can then search stored items using a search string that includes the r-smart criteria of “co-worker” and “friend”, retrieve the results of the search and then store the retrieved items together as an archived collection.

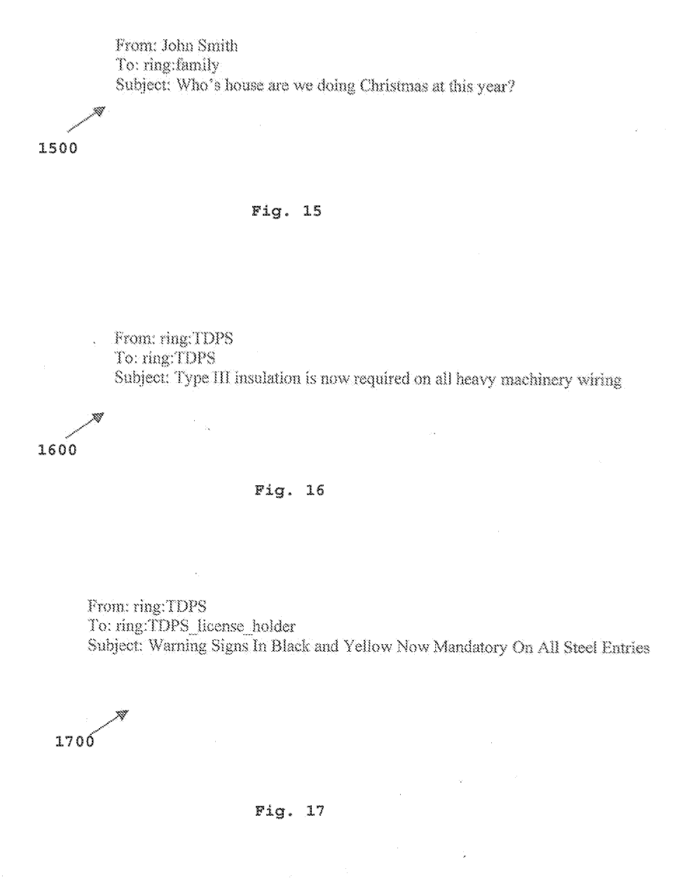

Emotient attributes associated with stored items can, in some implementations in accordance with claimed subject matter, be used to provide an enhanced communications list. In some implementations, for example, an address, such as an email address, can be associated with an emotient attribute such as the name of a relationship ring, and, thus, by using that address a communication can be sent to every contact that belongs to the associated ring. Thus, for example, a user who has defined a “family” ring can send email to the members of that ring with a single mail header. For instance, FIG. 15 illustrates, in accordance with claimed subject matter, an example email header 1500 directed to a “family” ring.

While relationship rings in accordance with claimed subject matter can be defined locally to a particular user and/or application, in some implementations in accordance with claimed subject matter, a user of a relationship ring system can want to share his or her ring definitions with other users.

Thus, in some implementations of claimed subject matter features can allow ring definitions to be sent to and integrated on a remote system. In some implementations, ring definitions can be automatically sent to and integrated on a remote system. In some implementations ring definitions can comprise a ring name and associated properties and can comprise ASCII text although claimed subject matter is not limited to any particular ring definition format. In some implementations, a ring definition can be sent as an attachment to a message.

Yet further, in some implementations of claimed subject matter, a message sender can remain anonymous and/or the sender's identity can comprise the sender's ring membership. For example, a sender can belong to a ring such as a committee ring, and the sender can wish to send a document resulting from a group effort. In this context the sender can be identified by the committee ring name. Another example can be where the sender is speaking in an official capacity for an organization defined as a ring. In yet another example the members of a ring can have a limited trust relationship and, hence, senders that belong to that ring can wish to remain anonymous when they send messages to other ring members. Of course, the preceding examples are just a few of many possible scenarios consistent with claimed subject matter.

FIG. 16 illustrates an item 1600, in this example an email message, wherein, in accordance with some implementations of claimed subject matter, a message can be identified (e.g., marked) as being associated with or originating from a particular relationship ring.

Further, in accordance with some implementations of claimed subject matter, an item, such as an email message, sent from a contact belonging to a particular ring does not have to be addressed to that ring, or, for that matter, to any other ring.

FIG. 17 illustrates an example email message 1700 wherein, in accordance with some implementations of claimed subject matter, a message can be identified (e.g., marked) as being associated with or originating from a particular relationship ring (e.g., the “Regulatory Board” ring) but can be sent to contacts outside the ring (e.g., to “Licensees” affected by actions of the “Regulatory Board” ring). In the example of FIG. 17, if a recipient of message 17000 replies to the ring:TDPS, the reply message can be delivered to all members of ring:TDPS. In some further implementations rules can cause a response from a licensee receiving message 17000 to be routed to an email account created especially for handling replies from license holders.

In accordance with some implementations, ring networks can be hierarchical in format. For example, a “family” ring or group can be further broken down into sub-rings or sub-groups such as “immediate family” (such as wife, son, daughter, etc.), and “extended family” (such as mom, dad, uncle, cousin, etc.). Such hierarchical groupings can extend for multiple levels of sub-rings; for example, “cousins” in an extended family ring might open up or be selectable to reveal a sub-ring providing a list of all cousins. Clearly, many such hierarchical ring scenarios are possible.

In such implementations, contact lists can be organized hierarchically amongst relationship rings and/or their sub-rings. Because one or more contacts can belong to multiple rings, it can be possible to associate items categorized by emotient attributes such as relationship rings with multiple conceptual indices. For example, in some implementations of claimed subject matter, the concept and/or term associated with a “role” as described herein can also comprise the name of a relationship ring. For instance, a contact in a “family” ring can play the role of “brother”. Clearly, a user can have multiple brothers. Thus, in some implementations of claimed subject matter, the term “brother” can comprise a description of a contact's role as a user's brother and/or comprise a name of a distinct relationship ring that contains all of the user's brothers. Hence, in accordance with claimed subject matter, r-smart criteria used to filter, search or archive stored items can simultaneously comprise acting roles and relationship ring names.

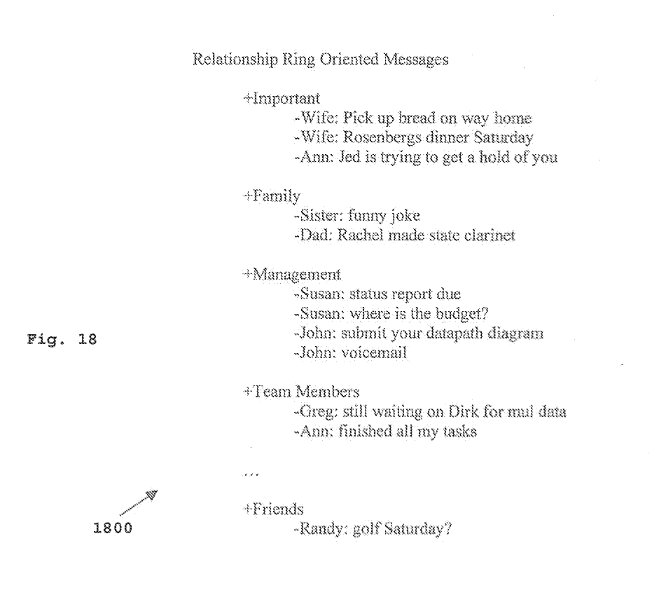

Furthermore, it is not necessary that a ring be a top-level ring or a sub-ring of another ring. Hence, in accordance with some implementations of claimed subject matter, relationship rings can comprise orthogonal rings that are independent of all other rings. In the context of orthogonal rings, when a sender, or a receiver, categorizes a item, or parts of an item, a plurality of relationship rings can be assigned to the item, so that the item can, correspondingly, be displayed in a plurality of contexts. Thus, for example, an item comprising a message from a user's brother can be displayed as associated with both the user's “family” ring, as well as in the user's “brother” ring. FIG. 18 illustrates relationship oriented items similar to those shown in FIG. 11, except that, in FIG. 18, a message 1800 from “Ann” is displayed associated with both the “important” and in “team members”. In this context indications associating an item with two rings may not comprise two different copies of the same item, but rather, can comprise the same item being referenced from two distinct points in an index into a database.

Another Example Method Related to Associating Data with R-Smart Criteria

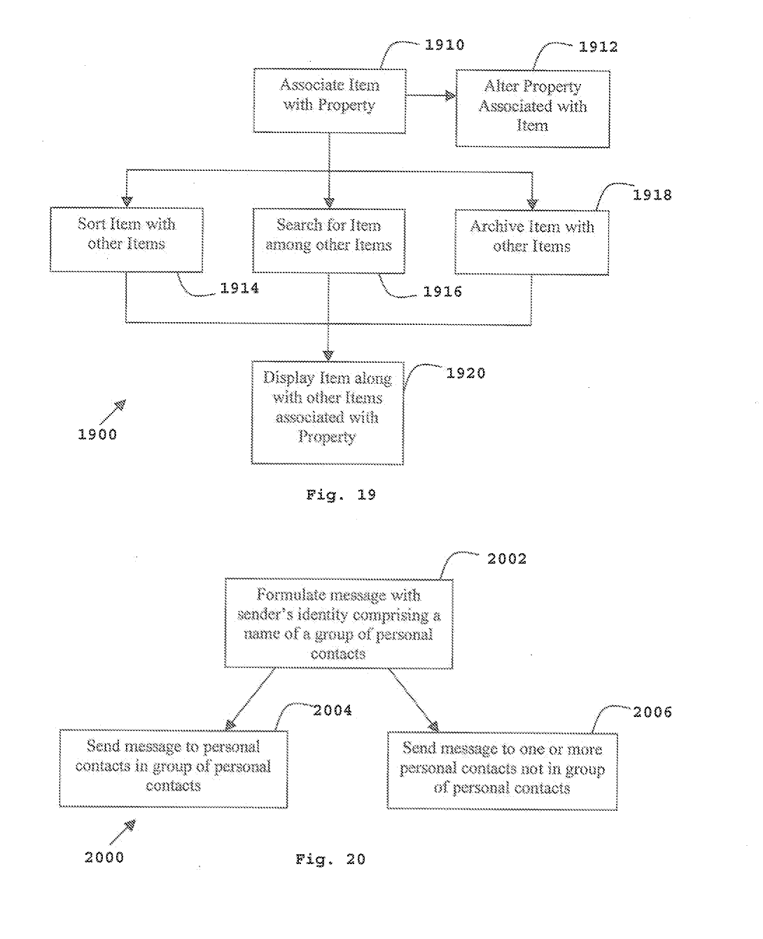

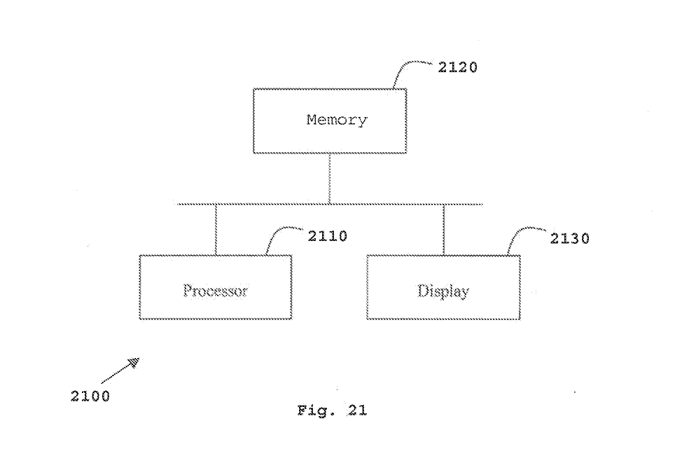

FIGS. 19 and 20 are flow diagrams of example respective methods 1900 and 2000 in accordance with some implementations of claimed subject matter. Methods 1900 and/or 2000 can implement and/or perform some or all of the various functions and/or schemes discussed in connection with FIGS. 11-18 and 21, and details regarding at least portions of the various acts of methods 1900 and 2000 have been provided in reference to those figures and may not be repeated below in the discussion of FIGS. 19 and 20. Any ordering of the acts shown in FIGS. 19 and 20 does not limit claimed subject matter and does not imply that the acts must be undertaken in the order shown and/or that any particular act in either of FIG. 19 or FIG. 20 is necessarily dependent upon another act. Further, in the description of FIGS. 19 and 20 that follows, references to the display of items can refer to display of an associated item header along with an item or to display of an associated item header alone. Similarly, while some acts of FIGS. 19 and/or 20 can call for display of an item, those skilled in the art will recognize that display of an item can comprise display of an indicator of an item such as an item header.

With regard to FIG. 19 and method 1900, an item can be associated with a property in act 1910. In act 1912 the property associated with the item can be altered. In acts 1914-1918, the stored item can be respectively sorted, searched for, or archived. In act 1920 the item, or an indicator thereof, can be displayed (e.g., on a display of a terminal device).

With regard to FIG. 20 and method 2000, a message can be formulated in act 2002 where that message includes an indicator of a sender of the message comprising a name of a group of personal contacts. In act 2004 the message can be sent to one or more personal contacts in the group of personal contacts, while in act 2006 the message can be sent to one or more personal contacts not in the group of personal contacts.

### Example System

FIG. 21 is a block diagram of an example system 2100. System 2100 can be used to perform some or all of the various functions discussed above in connection with FIGS. 1-20. System 2100 can comprise any device or collection of devices capable of facilitating communication and/or storage of information. For example, system 2100 can comprise a terminal device such as a desktop computer, a laptop computer, a handheld computer, a smart telephone and/or cellular telephone, a PDA, etc.

System 2100 includes a central processing unit (CPU) or processor 2110 such as a processor capable of providing and/or facilitating communications and/or data management functions, memory 2120 coupled to CPU 2110, and a display device 2130 coupled to CPU 2110 and/or memory 2120. It will be recognized by those skilled in the art that a graphics processing unit (GPU), not shown in FIG. 21, can be coupled to CPU 2110 and/or can be internal to CPU 2110, and can be coupled to display device 2130 in order to provide display device 2130 with displayable information. Such displayable information can be presented on display device 2130 in the form of a GUI that can be capable of providing visual representations of r-smart person-centric networks, messages, emotient managers, indicators associated with stored items, etc. in accordance with some implementations of claimed subject matter.

In accordance with some implementations of claimed subject matter, CPU 2110 can include logic adapted to facilitate, build, generate, and/or operate on internal representations such as list structures, data structures, and/or arrays used to define r-smart person-centric networks, to organize stored items associated with emotient attributes, to associate emotient attributes with items, and/or to alter emotient attributes associated with items. Further, in accordance with some implementations of claimed subject matter, memory 2120 can act in conjunction with CPU 2110 to store or hold at least portions of such internal representations.

In this context, memory 2120 and/or CPU 2110 can act to provide the functionality of a data store for storing items associated with emotient attributes. Hence, memory 2120 can store items that are to be sorted, searched, and/or archived in response to r-smart criteria such as emotient attributes.

Those skilled in the art will recognize that memory 2120 and/or CPU 2110 can be further coupled to a memory controller, not shown in FIG. 21, that can facilitate the communication of information, such as information specifying a GUI, between CPU 2110 and/or memory 2120. Further, memory 2120 can be any device or collection of devices that provide for the storage of data. For example, memory 2120 can comprise a hard disk drive (HDD) or some other magnetic storage media or can comprise optical storage technology. Alternatively, memory 2120 can comprise memory internal to CPU 2110, and/or can comprise one or more discrete memory devices external to CPU 2110, can comprise any memory technology (e.g., random access memory (RAM), flash memory, etc.). In accordance with some implementations of claimed subject matter, memory 2120 can, at least temporarily, store or hold information capable of providing visual representations of r-smart person-centric networks and/or indicators (e.g., icons) associated with stored items. Such information can comprise, for example, information specifying at least portions of a GUI capable of providing visual representations of r-smart person-centric networks and/or arrangements or collections of stored items, and capable of being displayed on display device 2130.

Display device 2130 can comprise any type of display device such as a Liquid Crystal Display (LCD) display, a polymer-based display, an electroluminescent display, a Plasma Display Panel (PDP), or a Cathode Ray Tube (CRT) display, to name a few of the more prominent examples. Although example system 2100 is shown with a particular configuration of components, other implementations are possible using any of a wide range of configurations. Further, those skilled in the art will recognize that system 2100 can include many additional components such as communications busses, etc. that, being not particularly germane to claimed subject matter, have not been illustrated in FIG. 2100 in the interests of not obscuring claimed subject matter.

While particular implementations have just been described, claimed subject matter is not limited in scope to one or more particular implementations. For example, some implementations can be in hardware, such as employed to operate on a device or combination of devices, for example, whereas other implementations can be in software. Further, some implementations can be employed in firmware, or as any combination of hardware, software, and/or firmware, for example. Likewise, although claimed subject matter is not limited in scope in this respect, some implementations can comprise one or more articles, such as a storage medium or storage media. This storage media, such as, one or more CD-ROMs, computer disks, flash memory, or the like, for example, can have instructions stored thereon, that, when executed by a system, such as a computer system, computing platform, or other system, for example, can result in execution of an implementation of a method in accordance with claimed subject matter, such as one of the implementations previously described, for example. As one potential example, a computing platform can include one or more processing units or processors, one or more input/output devices, such as a display, a keyboard and/or a mouse, and/or one or more memories, such as static random access memory, dynamic random access memory, flash memory, and/or a hard drive.

Reference in the specification to “an implementation,” “one implementation,” “some implementations,” or “other implementations” can mean that a particular feature, structure, or characteristic described in connection with one or more implementations can be included in at least some implementations, but not necessarily in all implementations. The various appearances of “an implementation,” “one implementation,” or “some implementations” in the preceding description are not necessarily all referring to the same implementations. Also, as used herein, the article “a” includes one or more items. Moreover, when terms or phrases such as “coupled” or “responsive” or “in response to” or “in communication with” are used herein or in the claims that follow, these terms should be interpreted broadly. For example, the phrase “coupled to” can refer to being communicatively, electrically and/or operatively coupled as appropriate for the context in which the phrase is used.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
associating respective emotient attributes with contacts utilizing respective index values; and
grouping at least two contacts of the contacts into a group based on at least one index value of the index values.

2. The method of claim 1, wherein the associating further includes associating, with the at least two contacts, at least one of: a familiarity with the at least two contacts, an affection for the at least two contacts, a respect for the at least two contacts, an esteem for the at least two contacts, or an acting role of the at least two contacts.

3. The method of claim 1, further comprising:
deriving an emotient attribute of the respective emotient attributes according to a number of contacts of the at least two contacts.

4. The method of claim 1, wherein the grouping includes grouping the at least two contacts into a relationship ring based on at least one of a familiarity with the group, an affection for the group, a respect for the group, an esteem for the group, or an acting role of the group.

5. The method of claim 4, wherein the grouping the at least two contacts into the relationship ring further includes dividing at least two contacts into at least one of sub-groups or sub-rings.

6. The method of claim 5, further comprising selecting the at least one of the sub-groups or the sub-rings based on at least one emotient attribute of the respective emotient attributes.

7. The method of claim 1, further comprising:
defining an event by at least one of a time interval or a scenario related to the time interval;
receiving, during the event, a message from a contact of the contacts including information associated with the contact; and
determining, based on the information, a membership of the contact in the group.

8. The method of claim 7, further comprising:
rendering, based on the message, a notification including selecting a type of the notification based on the information.

9. The method of claim 7, further comprising:
modifying a level of a notification according to the membership; and
providing the notification to the contact based on the level.

10. The method of claim 9, wherein the modifying further includes modifying at least one of a volume of the notification or a vibration level of the notification based on the membership.

11. The method of claim 7, wherein the receiving the message further includes receiving at least one of a name of the contact, an acting role of the contact, or an indication of a membership of the contact in the group.

12. An apparatus, comprising:
a display component configured to:
provide a representation of groups of contacts sharing respective emotient attributes based on respective index values; and
a processing component configured to:
receive, via an input interface, criteria for selecting a group of the groups according to at least one emotient attribute of the respective emotient attributes.

13. The apparatus of claim 12, wherein the processing component is further configured to:
receive, via the input interface, input for grouping at least two contacts of the group into a relationship ring based on at least one of a familiarity with the group, an affection for the group, a respect for the group, an esteem for the group, or an acting role of the group.

14. The apparatus of claim 12, wherein the processing component is further configured to:
receive, via the input interface, input for selecting information based on an emotient attribute of the respective emotient attributes; wherein the display component is further configured to display at least a portion of the information.

15. A computer readable storage medium comprising computer executable instructions that, in response to execution by a computing device, cause the computing device to perform operations comprising:
receiving an emotient property of a contact associated with information; and
associating the emotient property with the information utilizing an index value.

16. The computer readable storage medium of claim 15, wherein the receiving the emotient property further includes:
receiving an indication of at least one of: a familiarity with the contact, an affection for the contact, a respect for the contact, an esteem for the contact, or an acting role of the contact.

17. The computer readable storage medium of claim 15, wherein the associating the emotient property further includes:
grouping items of the information into an information ring based on at least one of a familiarity with the contact, an affection for the contact, a respect for the contact, an esteem for the contact, or an acting role of the contact.

18. The computer readable storage medium of claim 15, the operations further comprising:
providing at least a portion of the information based on the index value.

19. The computer readable storage medium of claim 18, wherein the providing further includes providing at least one of an image or a file based on the index value.

20. An apparatus, comprising:
means for associating an emotient attribute with a contact utilizing an index value; and
means for generating, based on the index value, a group including the contact and another contact.

21. The apparatus of claim 20, wherein the emotient attribute includes at least one of a familiarity with the contact, an affection for the contact, a respect for the contact, an esteem for the contact, or an acting role of the contact.

22. The apparatus of claim 20, further comprising:
means for including the contact in a relationship ring of contacts based on at least one of a familiarity with the contact, an affection for the contact, a respect for the contact, an esteem for the contact, or an acting role of the contact.

23. The apparatus of claim 20, further comprising:
means for associating an event with at least one of an interval of time or a scenario related to the interval of time;
means for receiving, during the event, a message from the contact including information associated with the contact; and
means for determining, based on the information, a status of the contact in the group.

24. The apparatus of claim 23, further comprising:
means for modifying a notification level according to the status; and
means for generating the notification according to the level.

25. The apparatus of claim 20, further comprising:
means for providing at least one of an image or a file based on the index value.
